(19) United States
(12) Patent Application Publication
(10) Pub. No.: US 2024/0052673 A1
(43) Pub. Date: Feb. 15, 2024

(54) CENTRALLY CONTROLLED LOCKS

(71) Applicant: Richard Joseph Morris, Discovery Bay, CA (US)

(72) Inventor: Richard Joseph Morris, Discovery Bay, CA (US)

(21) Appl. No.: 17/766,207

(22) PCT Filed: Oct. 4, 2019
(86) PCT No.: PCT/US2019/054876

§ 371 Date: Apr. 1, 2022

(51) Int. Cl. E05B 47/00; E05B 65/00; E05B 41/00

(52) U.S. Cl. CPC E05B 47/0002; E05B 65/0003; E05B 41/00; E05B 65/0007; E05B 2047/0054; E05B 2047/0058; E05B 2047/0095

(57) ABSTRACT

The system is a plurality of electromagnetic locking devices (linear electromagnetic actuators) coupled to a controller. The system substantially comprises a remote control unit wirelessly coupled to the controller to lock or unlock the electromagnetic locking devices built into a gate, cabinet, door or other appropriate housing unit, wherein a user can remotely control the opening and closing of doors, gates, drawers, cabinets and the like.

### CROSS-REFERENCE TO RELATED APPLICATION(S)

This application claims the benefit of priority prior-filed and co-pending PCT Patent Application No. PCT/US2019/054876, filed on Oct. 4, 2019 by Richard Joseph Morris, the complete content of which is hereby incorporated herein by reference.

### BACKGROUND

### Field of the Disclosure

The disclosure relates to the field of automated remote computer/app-controlled linear electromagnetic actuator, safety, childproofing, alert and information systems.

### Background of the Invention

The purpose of this system is to add convenience and safety to the daily life of parents, teachers, nurseries, day care providers, doctors offices, etc. in order to prevent children, pets or elderly people from coming in contact with items that may present a health risk for them or to prevent from theft. This system works so as to give ingress/egress control to the user by ensuring separate rooms, doorways and atriums, kitchen and bathroom cabinet drawers, doors, medicine cabinets, nightstands, dressers and desks are secured lock with a push of a switch, wireless remote unit, or an app from mobile phone or tablet.

The SMART BABY GATE Childproof Linear Electromagnetic Actuator locking system works by enabling the user full control to unlock all gates, kitchen and bathroom cabinet drawers and doors at same time to eliminate the hassle of fighting with existing baby proofed doors and drawers by unlocking one at a time.

The system is designed to work in a manor as when there are no activities taking place in kitchen, bathroom, etc., they will lock all the doors and drawers simultaneously by pushing a switch, remote control or using an app from their phone or tablet. When the adult decides it time to seal off a doorway-atrium, or to work in the kitchen to prepare a meal, they will unlock the proper gate, doors and drawers {inter alia) simultaneously in the same manor by pushing the unlock switch, using remote control or using the app to unlock (or choosing proper menu prompts and commands via app or program). The user(s) will also have the ability to see if all doors are locked via a light that is integrated in the switch or a standalone light or via the app on the mobile phone, tablet or computer. (If there is the need to keep all doors and drawers locked because a child is around and individual doors or drawers need to be open at a time it can be done either through the app or a remote control).

The system is designed to be operable in the event of a power failure or a defect from the system. There is a manual unlock tool that can be utilized in the event of power or system failure. There are preset dimensions re: percentage of cabinet/door/drawer/doorway/door-frame hallway (via inter alia pressure rod) are allowed to open in the locked position to allow insertion of the unlock tool to release or retract the linear electromagnetic actuator.

### SUMMARY OF THE INVENTION

The instant invention is a system for remotely locking and unlocking one or multiple gates, storage units (e.g. gates, drawers, cabinets) simultaneously or selectively. The storage units can include, for example, cabinet doors and drawers in the kitchen, living room, bathrooms, and so on. Likewise, the gates are for hallways, doorways, outdoor regions, etc.

The system comprises a controller, described infra and supra.

The system works via a plurality of electromagnetic locking devices (herein “linear electromagnetic actuators”) coupled to the controller. The system further comprises a remote control unit that is [preferred embodiment] wirelessly coupled to the controller.

The remote control unit allows the user to send instructions to the controller to either simultaneously lock or unlock all the electromagnetic locking devices associated with the controller or facilitate the locking and unlocking of any particular electromagnetic device associated with the controller.

The system is designed to work with different types of linear electromagnetic actuators. The linear electromagnetic actuator can incorporate electromagnets in addition to (or in lieu of) linear electromagnets based on ease of installation for example linear electromagnetic actuator can be various styles and types based on clearances of the application (gates, drawers/cabinets, doors etc) certain demotions or clearances may require push pull linear electromagnetic actuator. In some instances, the system may require a linear electromagnetic actuator with an angled lock looking style like a door latch/lock that will slide on to the hole port location, a magnet style can be utilized as well.

### BRIEF DESCRIPTION OF THE DRAWINGS

FIG. 1: Front view of an exemplary gate of the instant invention;

FIG. 2: Front view of an exemplary gate and smartphone utilizing the Sytem's mobile app;

FIG. 3: Front view of the gate and RF Remote Controller;

FIG. 4: Front view of System controller and power source3

FIG. 5 Substantially exploded view of System Controller and components comprised therein;

FIG. 6 Elevational view of system components

FIG. 7 Front view of RF components of system

FIG. 8 Front view of RF components and accessories of system

FIG. 9 Perspective view of RF reader

FIG. 10 Front view of reader and scanner

FIG. 11 Zoomed view of biometric fingerprint and code reader

FIGS. 12A-D Front view of mobile application graphical user interface menu options

FIGS. 13 A-G Partially exploded view of RFID Wifi Controller

FIG. 14 Front view of System's electronics-accessible hinge mount apparatus for gate and door/cabinets with screw holes noting location to secure attachment to underlying surface of door/cabinet. Wire enters the top off-centered to the right on the mounting apparatus.

FIG. 15 Front internal view of control panel to actuator (in one embodiment). Control panel is located in electrical panel receiving electric power wiring and connected to outgoing wiring to actuator. Directly connected to control panel is RF ID receiver on the right. Wifi is built in and seen on control panel. Relay systems visible on control panel direct electric signals via outgoing wiring.

FIG. 16 Front view of lock mechanism comprising actuator and electrics. Electric wiring from control panel is visible entering the lock. Screw holes in place represent firm enclosure of metal housing over lock components. Side mounting empty holes note location to place screws for mounting entire device.

FIG. 17 Side view of System installation components, herein actuator, controller and door/gate mount. Wiring enters control panel where wireless communications allow electrical signals to be delivered to lock mounted on door/gate.

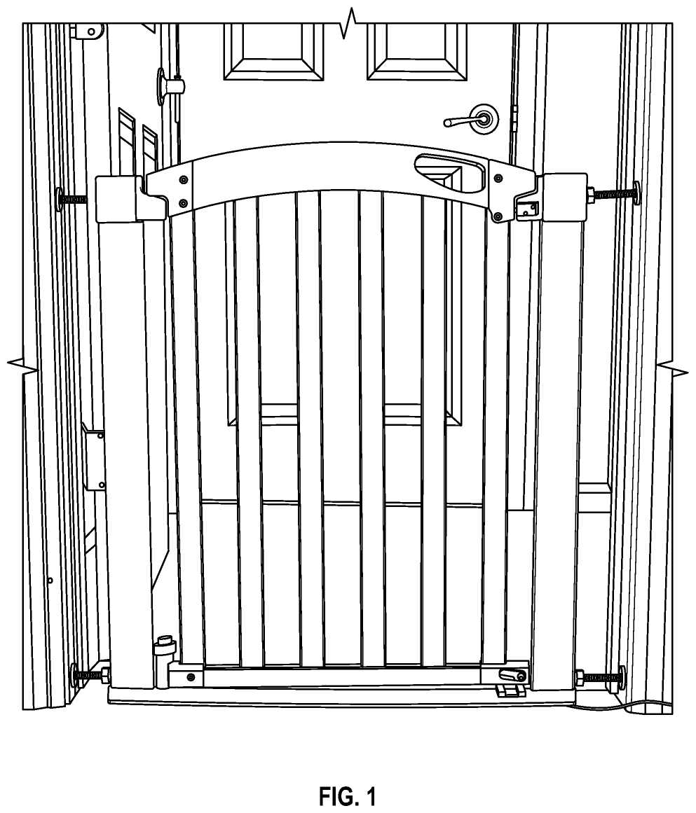

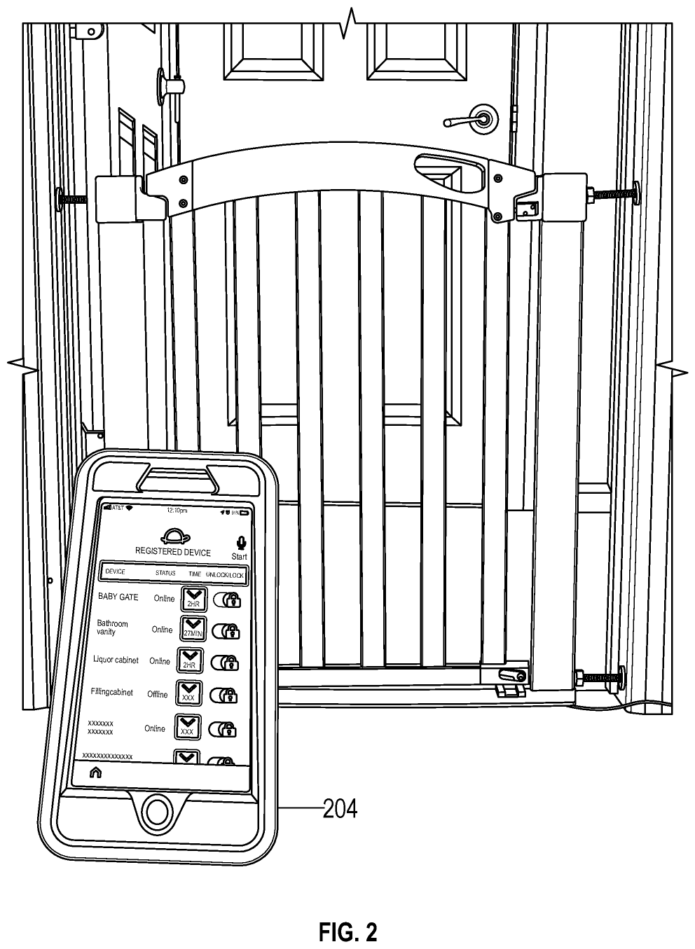

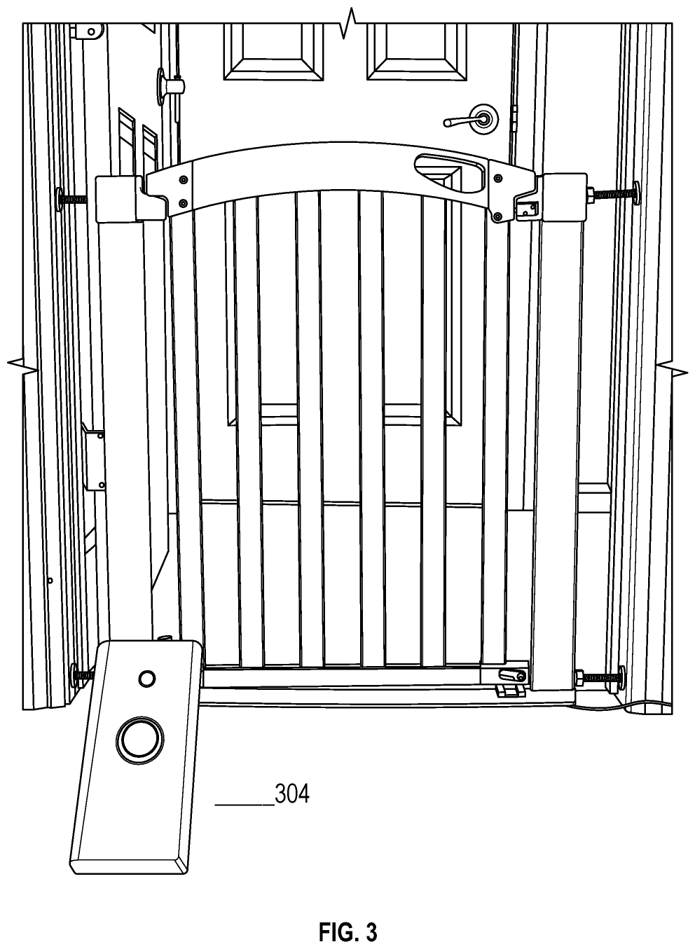

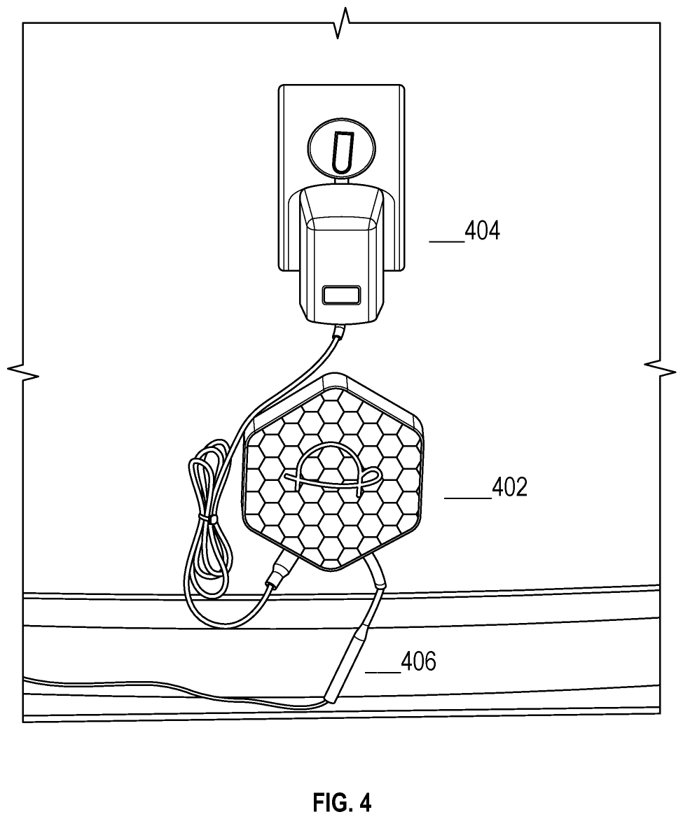

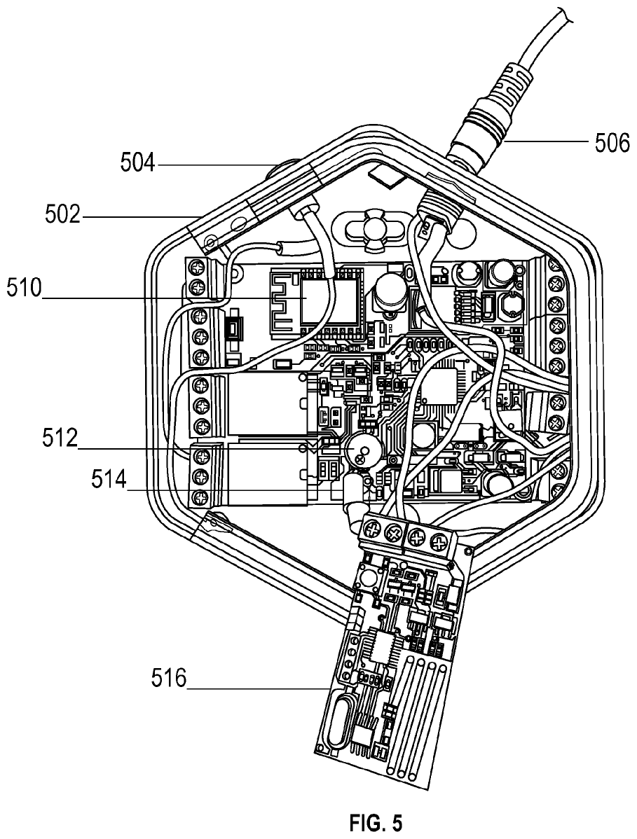

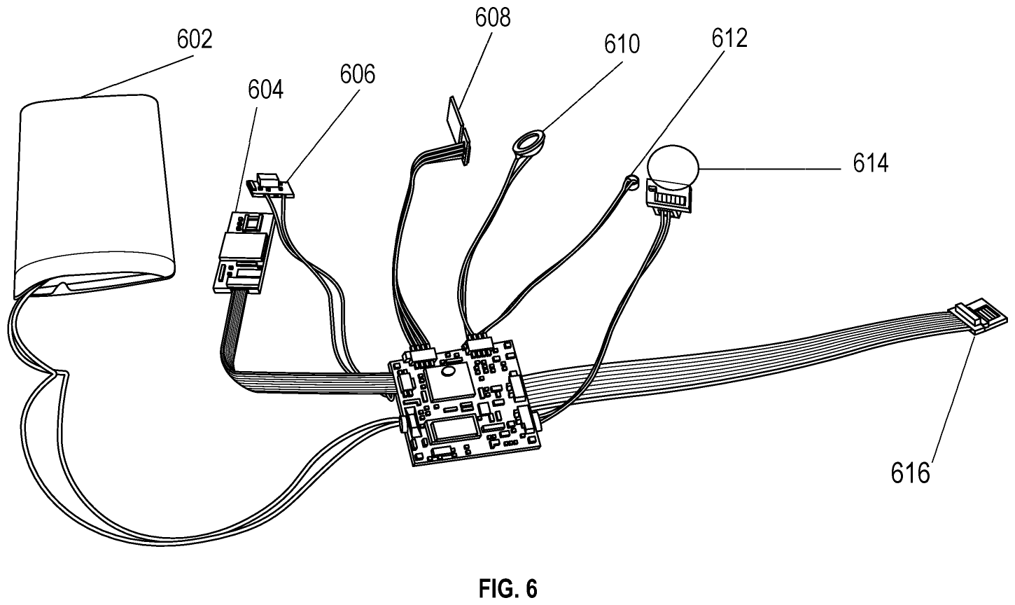

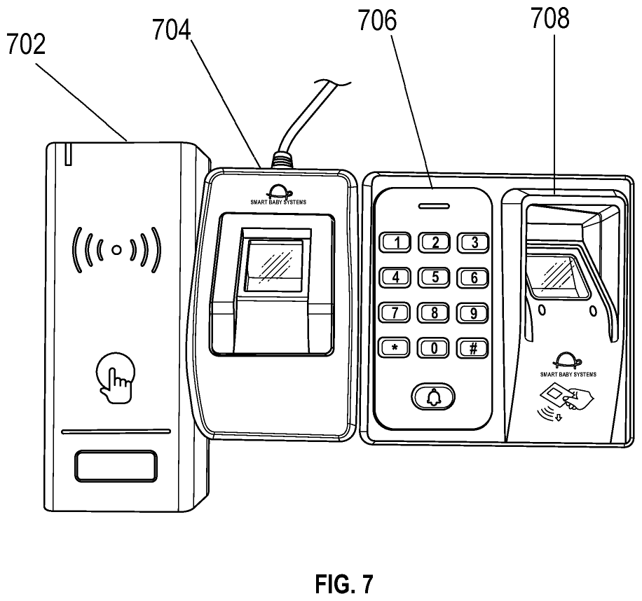

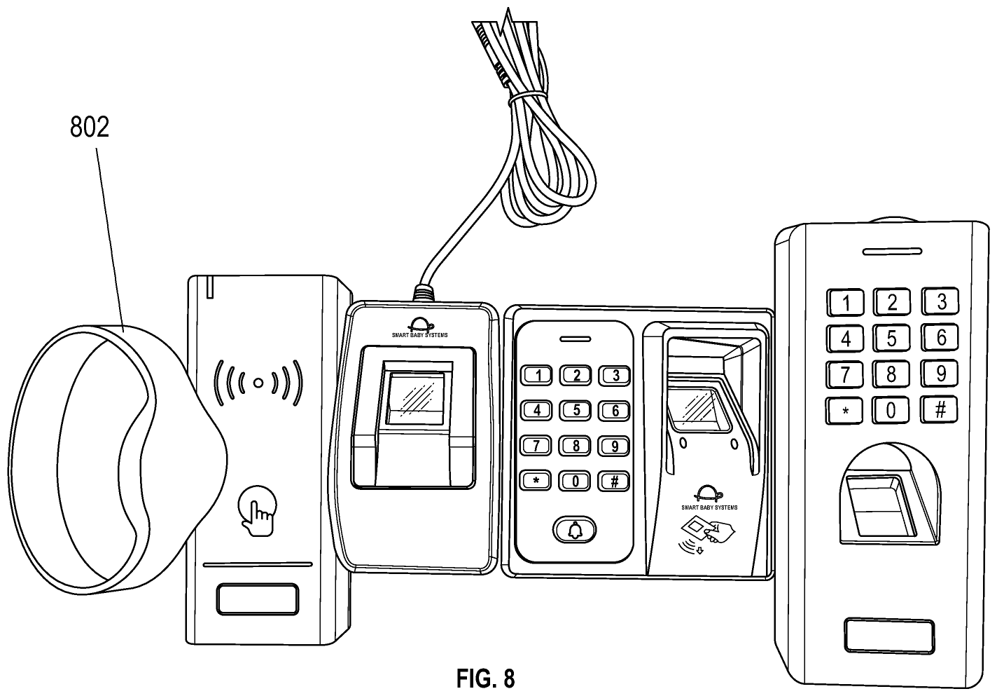

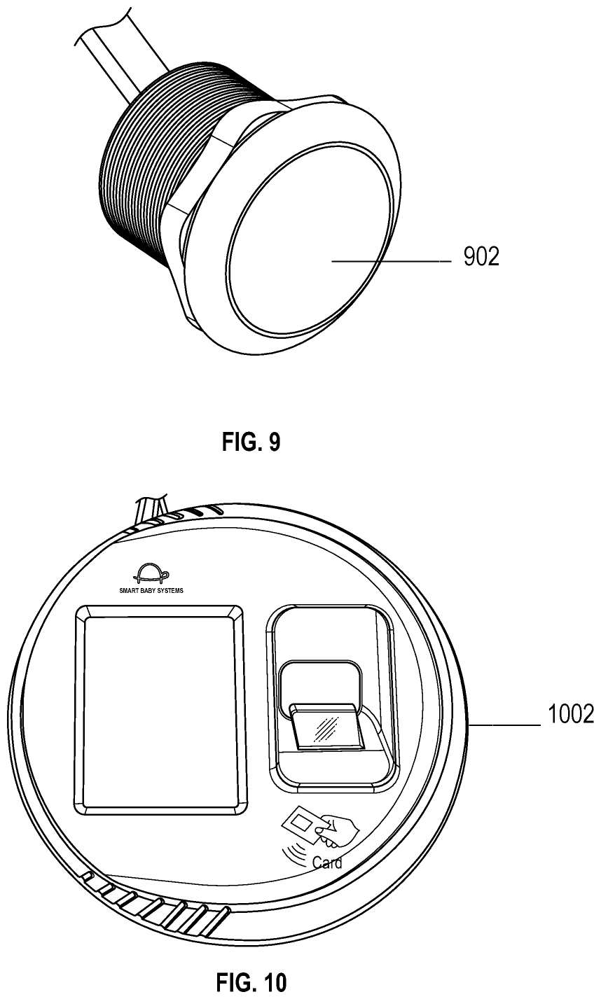

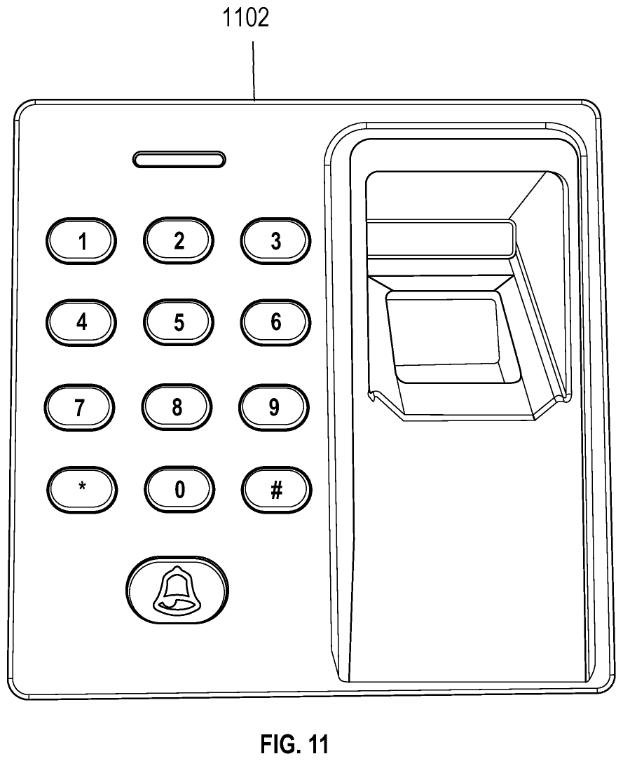

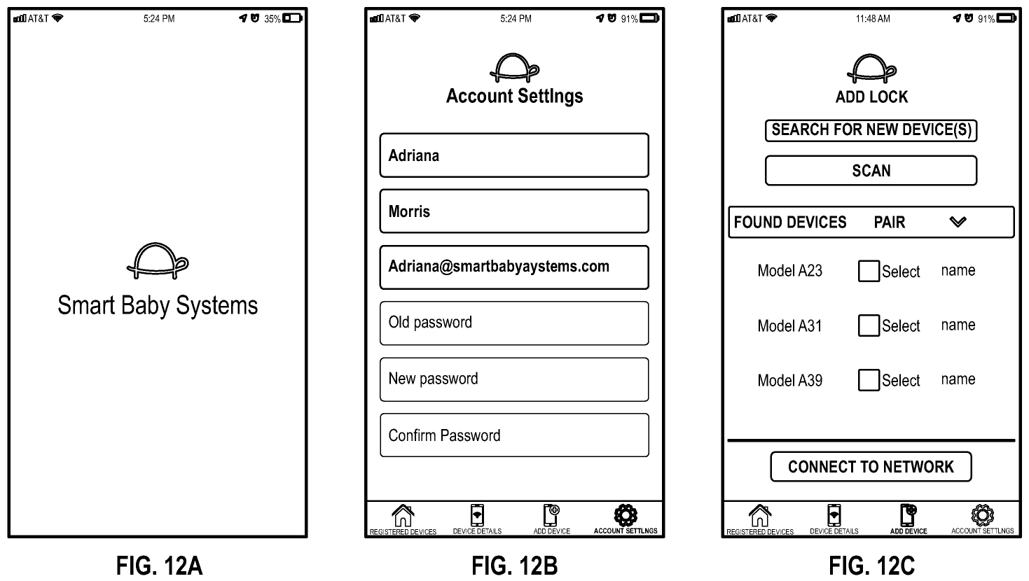

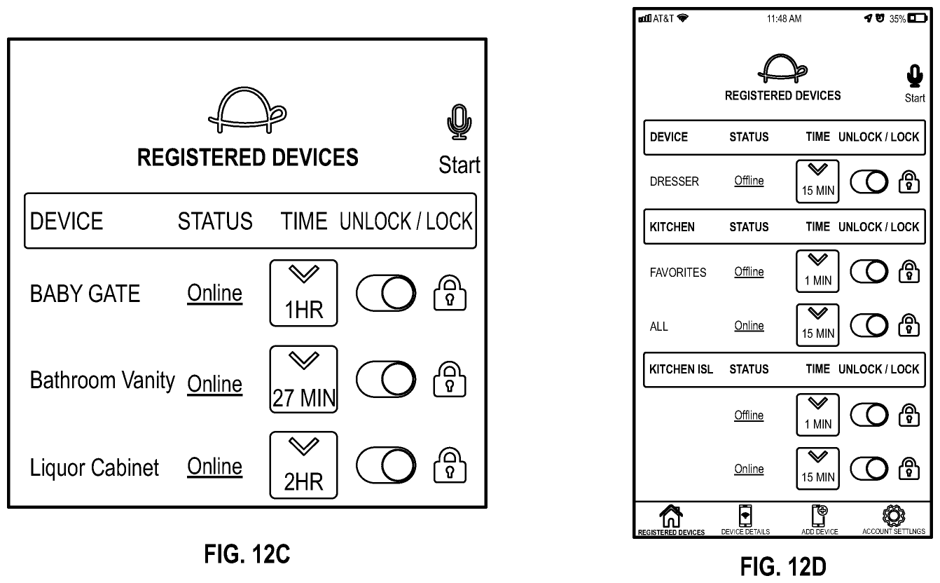

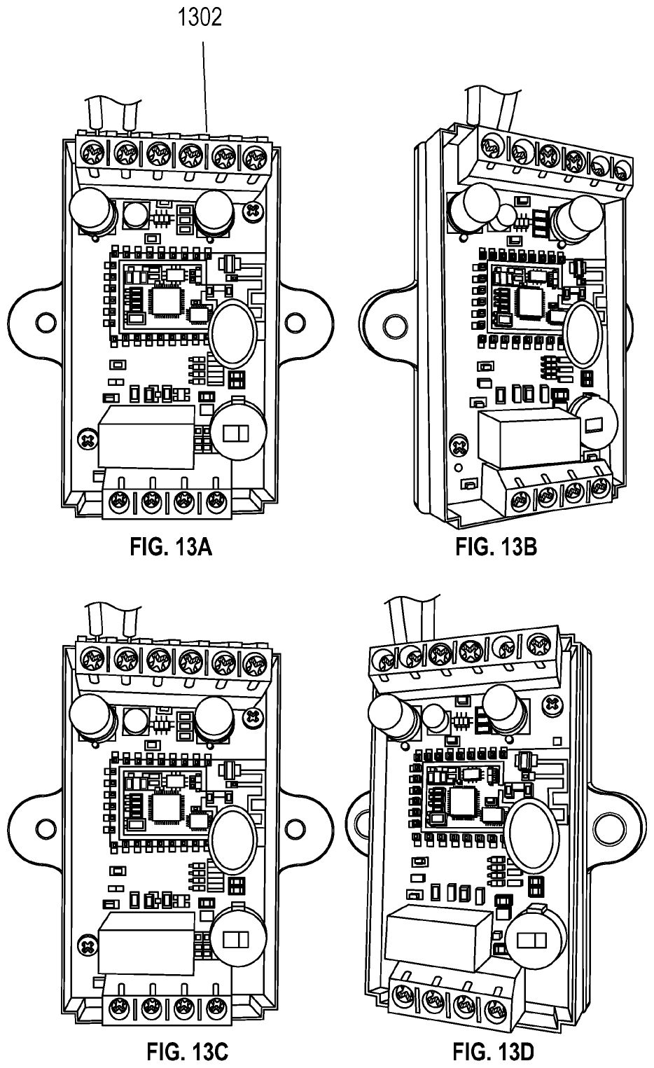

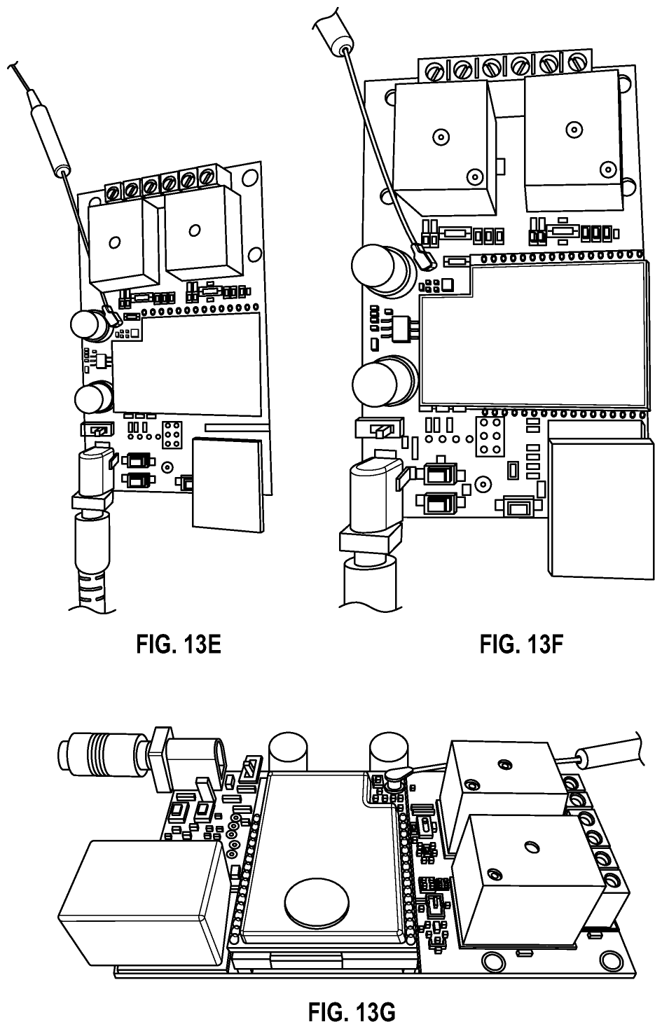

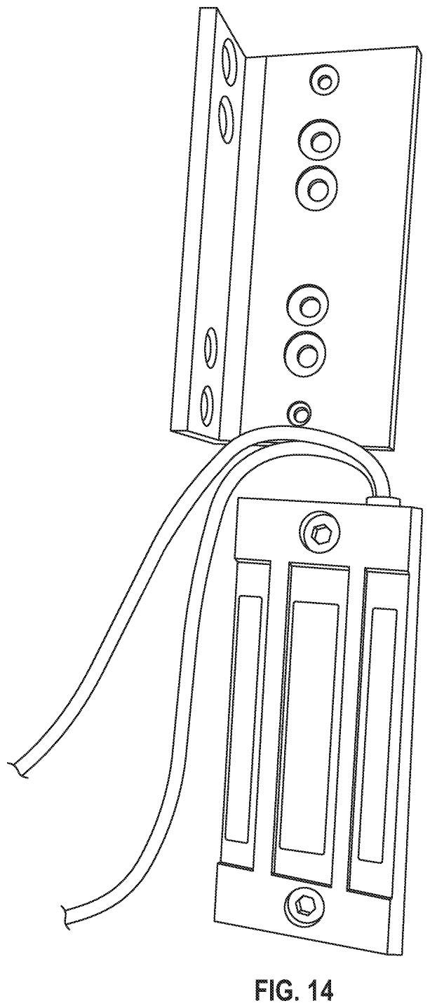

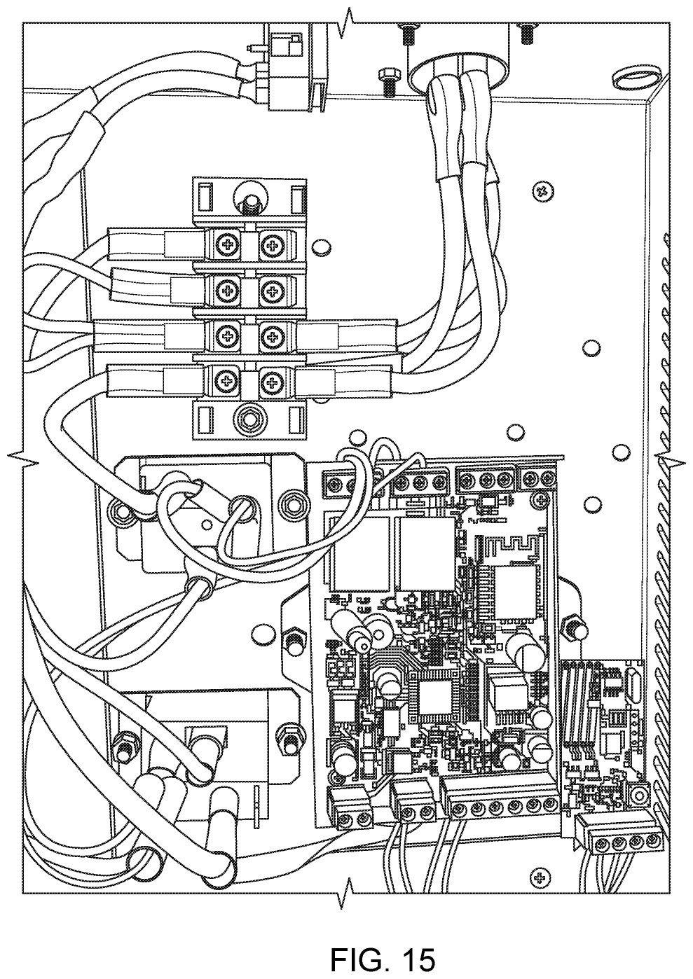

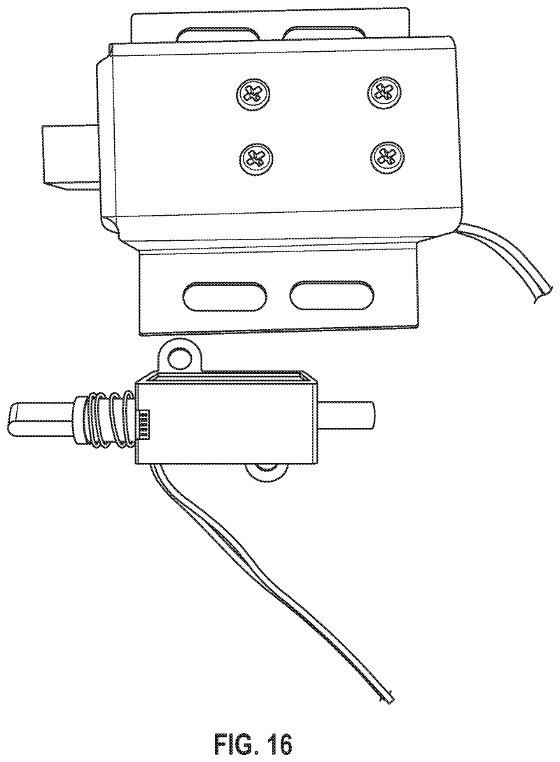

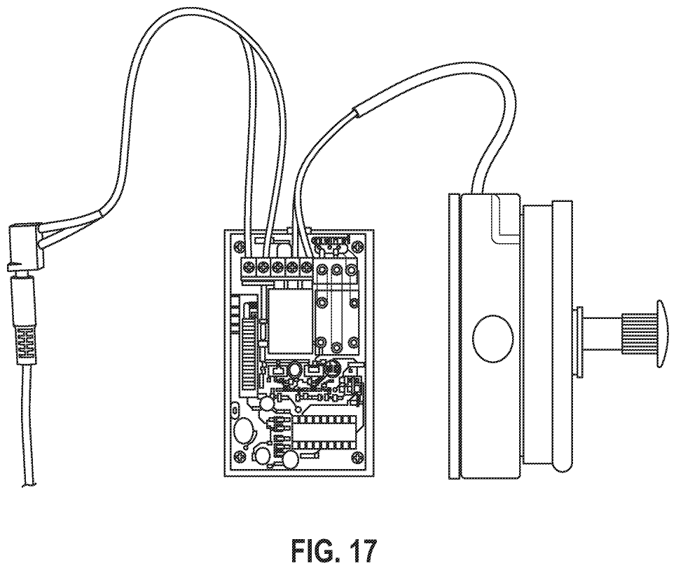

### DETAILED DESCRIPTION OF THE DRAWINGS (TO WIT, COMPONENTS)

204 Smart phone running mobile application connected to WiFi chip on controller which sends RF signal to Gate Actuator to unlock (customarily single relay)
304. RF remote, send signal to the RF chip in controller
402 Controller
404 Power adapter_converter/power supply
406 Power cord
408 RF chip card input/wired in to PCBoard; sends signal to relay to unlock gate
410 LED indicator of gate status (open/closed)
502 Pairing button (wifi controller)
504 Wiring to unlock gate
506 Controller power: BATTERY PACK BEYOND 10 HRS; or standard Power; ASDC adaptor inout 100-240 volt AC 50-60 hz 0.3 amps output: 12 v . . . lamp or appropriate power source.
508 Wegan protocol [RFID reader communicates with PCB to unlock gate]
510 Wifi Chip
512 Alarm module
514 LED Light indicator (when RF signal is sent)
516 RFID Chip (ONLY ONE RELAY NEEDED)
602 POWER SOURCE (HEREIN SHOWN BATTERY PACK) (current life>10 hrs); Power; AS/DC adaptor inout 100-240 volt AC 50-60 hz 0.3 amps output: 12 v . . . lamp or appropriate power source.
604 Micro SD (Secure Digital) Memory Card
606 USB Port
608 Wifi Card
610 Speaker
612 Microphone
614 Motion Sensor(s)
616 Flush mounted video camera
702 RF Remote
704 Fingerprint biometric reader
706 NC/CNC Access Code Unit
708 RFID READER AND FIGNGERPRINT READER
802 RF remote with Wearable Bracelet
902 RF Reader shown zoomed/close-up
1002: Reader and Fingerprint Sensor
1102: Fingerprint and Code Pad
1202: App with GUI's with Menus Settings and Options shown.
1302 (A-D): Compact controller with Built in RFID controller [alternate embodiment]
13E-G: Controller, wifi, RF reader, unit mounted onto gate: CPU [alternate embodiment] (note: gate comprises window for Antenna to prevent interference).

### Wired Embodiment

In the wired system, the controller is connected to all of the electromagnetic locking devices via wires. Both the controller and the electromagnetic locking devices can have special connectors for facilitating the connections (e.g., snap fit connectors (quick connect/disconnect), using screws for connection, and other appropriate means). The wires can also be soldered. Clamps or glue can be used to properly route the wires to prevent sagging of the wires. The remote control unit, in the wired system, is the only wireless component.

The electromagnetic locking devices have an “indicator light” function to indicate connection, e.g. LEDs. The indication means provides an indication of the electromagnetic locking device's state (e.g. being in a locked or in an unlocked condition). The indication means can also be configured to provide a discrete signal that can be used to indicate the locked or unlocked condition of the electromagnetic locking device on the controller has a receiver that can accept instructions from the remote control unit or the smart device connected the controller. Based on the user's instructions/prompts, the controller then provides appropriate signals for facilitating either simultaneous locking/unlocking of the electromagnetic locking devices or locking/unlocking of any particular electromagnetic locking device.

The power and ground required from the operation of the electromagnetic

locking devices is provided by the controller, which is operated via a batter pack or a supply from the main. It is to be noted that the electromagnetic locking devices are not constantly receiving positive current and are activated only after the controller receives a signal that requires the electromagnetic locking device to be locked or unlocked.

Different modes of operations can be configured and provided as options to the users. For example, child lock mode shall lock all the electromagnetic locking devices, whereas a guest mode can be used to keep the electromagnetic locking devices unlocked for a pre-determined time period.

In cases of system failure, an unlocking device can used to unlock the electromagnetic locking devices. Each electromagnetic device shall allow pre-determined movement of the locked elements, e.g., the door or the drawer to allow the insertion of the unlocking device for unlocking the same

### Wireless Embodiment

Substantially similar functionality to the above “wired” embodiment, except that the electromagnetic locking devices are wirelessly coupled to the controller. The electromagnetic locking devices are herein battery-operated. It is to be noted that the electromagnetic locking devices are not constantly activated and are activated only after the controller receives a particular signal that requires the electromagnetic locking device to be locked or unlocked.

The Linear Electromagnetic Actuators system is designed to operate from low voltage and low wattage AC or DC voltage. The linear electromagnet actuators can be mounted in various ways, they can be mounted to the door, drawer, door or drawer frame or they could be flush mounted in the door or drawer frame. The electrical power for the electromagnets is provided by the Electronic Controller when utilizing wired Linear Electromagnetic Actuators. When the linear electromagnet is energized it will pull the shaft in allowing for the door or drawer to open.

### System Operation

The system comprises of electronic controllers, linear electromagnetic actuators, actuator catches, limit/micro switches, wiring, wireless remote controller, a lock/unlock switch, gate, door unlock light, an app on mobile phone, tablet or computer.

### First Method: Wired Linear Electromagnetic Actuators

The Linear Electromagnet Actuators are electromagnets with a shaft that will be pushed or pulled depending on the polarity of the coil. The polarity will be manipulated to create the push or pull motion to lock or unlock. The Linear Electromagnetic Actuator can be mounted to the kitchen/bathroom cabinet door or drawer by means of screws, bolts, self-adhesive, or glue. The linear Electromagnetic Actuator may also be mounted to the door or drawer frame or gate.

In this method the Linear Electromagnetic Actuator will have wires connected to it that will provide electricity that are connected to the Electronic Controller, the wires may be secured with some sort of clip, clamp or wire holder that utilizes either self adhesive or screws. The wires that are connected to the Linear Electromagnetic Actuator can be connected to it by means of a connector with quick disconnect i.e. pull connector or a push a tab to release wire. The wires can also be crimped or soldered to existing wires on the linear electromagnetic actuator. The wires that are connected to the Electronic Controller will be connected via a quick disconnect push tab and insert wire, insert wire into clamp style where tightening screw will tighten clamp or a quick disconnect where wires are secured to mating side of connector and can be inserted into electronic controller.

The Linear electromagnetic actuator may have a set of contacts built within itself a stand alone switch maybe utilized that can be used to provide a visual indication of unlock/lock status when the linear electromagnetic actuator is extended the circuit or path for electricity to flow will be open, when the linear electromagnetic actuator shaft is retracted a path for electricity to flow is complete and provides the mean power and ground to the light to illuminate and also a discrete signal that can be used for the app based indications and control functions.

The power and ground will be supplied by the controller and the wires will be connected to the electronic controller in the same manor as the linear electronic actuator. The lock/unlock light can be indicated on the electronic controller that integrated to the unit or an external light can be mounted in a position that is visible using self adhesive or screws. Another function of the contacts in the linear electromagnetic actuator is that in addition to providing a visible indication of lock status it can provide a discrete signal that can be used to show the status of the lock status on an app viewable mobile app, phone or computer.

The Linear Electromagnetic Actuators are not continuously powered in either position locked or unlocked. They are powered to provide lock or unlock actuation, when power is removed from the Linear Electromagnetic Actuator they will keep the last actuated position until a command is received. They will actuate to new position and be powered down again. The Command for this logic is internal logic of the Electronic Controller.

The system is designed to be operable in the event of a power failure or a defect from the system. There will be an unlock tool that can be utilized in the event of power or system failure. There will be predetermined dimensions of how much the door or drawer will be allowed to open in the locked position to allow insertion of the unlock tool to release or retract the linear electromagnetic actuator.

The Electronic Controller receives electrical power from either a battery pack or is plugged into a wall outlet. In the event its connected to a battery pack the batteries can be disposable or rechargeable type.

The Electronic Controller contains the circuitry to send electricity to the linear electromagnetic actuators to dictate the polarity of the Linear Electromagnets Actuators to create push or retraction forces on the shaft to lock or unlock it. The Electronic Controller may be programmed with a preset time limit to automatically

Time delays (Example: 5 mn, 10 mn 30 mn, 1 hr) to lock all of the Linear Electromagnetic Actuators. The electronic controller may have an integral light mounted on the case that can illuminate to indicate an unlocked actuator to aide in set up of the system or for troubleshooting. The electronic controller will have an output with either a quick disconnect connector with a push tab to insert or release the wires, a screw type that secures the wire by squeezing them and securing in position. The controller will have a wireless function, a remote control can be utilized to lock or unlock the system.

The Electronic controller may utilize wireless signals to create commands to lock or unlock the system. The Electronic Controller may be connected to wired or wireless internet network. The electronic controller may have an integral or external antenna to aide in this function. The independent linear electromagnets & micro switches used per cabinet door or drawer will be referred to as channels. The electronic controller will have labels on the case of the unit “Channel 1” “Channel 2” etc. To aide in ease and understandable set up of the system. The Electronic controller may utilize a Lock/Unlock switch 106 that is either wired to the controller or utilizes wireless signal to provide a command to electronic controller, the wireless lock/unlock switch may utilize a battery as source of power.

### Alternate Method of Operation: Wireless Linear Electromagnetic

In this embodiment, the Actuators Lock/Unlock Signal from Electronic Controller. The Wireless Linear Electromagnet Actuators are electromagnets with a shaft that will be pushed or pulled depending on the polarity of the coil. The polarity will be manipulated to create the push or pull motion to lock or unlock. The Linear Electromagnet may also be fitted with an integral permanent magnet to hold shaft in a predetermined position.

The Wireless Linear Electromagnetic Actuator can be mounted to the kitchen/bathroom and desk cabinet door or drawer by means of screws, bolts, self-adhesive, or some sort of glue. The Wireless Linear Electromagnetic Actuator 40 may also be mounted to the door or drawer frame.

In this method the Wireless Linear Electromagnetic Actuator will be connected to a battery or connected to a power source via wires. The battery for the Wireless Linear Electromagnetic Actuator be consolidated within case of Linear electromagnet actuator or a stand alone battery. When the Wireless Linear Electromagnetic Actuator receives the command from the Electronic Receiver. The polarity of the Wireless Linear Electromagnetic Actuator may be manipulated to cause the shaft to move in the desired direction to lock or unlock.

The Wireless Linear Electromagnetic Actuator can be connected to a battery or plugged into an outlet it by means of a connector with quick disconnect i.e. pull apart connector or a push a tab to release wire. The wires can also be crimped or soldered to existing wires on the Wireless Linear Electromagnetic Actuator

Wireless Linear Electromagnetic Actuators are not continuously powered in either position locked or unlocked. They are powered to provide lock or unlock actuation, when power is removed from the Linear Electromagnetic Actuator they will keep the last actuated position until a command is received. They will actuate to a new position and be powered down again. The Command for this logic is internal logic of the Electronic Controller.

The Electronic Controller receives electrical power from either a battery pack or is plugged into a wall outlet. In the even its connected to a battery pack the batteries can be disposable or rechargeable type, and connected via a quick disconnect.

The Electronic Controller contains the circuitry to send wireless command signal to the wireless linear electromagnetic actuators to dictate the polarity of the wireless linear electromagnets actuators to create push or pull forces on the shaft to lock or unlock it. The Electronic Controller may be programmed with a preset time limit to automatically lock all of the Linear Electromagnetic Actuators or it may have an “off switch with variable time delays (Example: 5 mn, 10 mn 30 mn, 1 hr) to lock all of the Linear Electromagnetic Actuators. The controller will have a wireless function, a remote control can be utilized to lock or unlock the system. The Electronic controller may utilize wireless signal(s) to create commands to lock or unlock the system. The electronic controller may have an integral or external antenna to aide in this function. The Electronic Controller may utilize a Lock/Unlock Switch that is wired to the controller or a wireless switch that sends signal to the controller, this option would require either battery pack or to be plugged into wall outlet.

The system is designed to be operable in the event of a power failure or a defect from the system. There will be an unlock tool that can be utilized in the event of power or system failure. There will be predetermined dimensions of how much the door or drawer will be allowed to open in the locked position to allow insertion of the unlock tool to release or retract the linear electromagnetic actuator.

The electronic controller consists of a PCB board that has WiFi antenna. The PCB Board (printed circuit board) has a WiFi Antenna [and depending on the enclosure chosen for the application] the antenna is embedded in the PCB or it can be externally mounted for better signal. The PCB has capability to connect via Bluetooth as well.

The PCB Board receives electrical power from either wall outlet 120 V transformed to 5-12 DC voltage. When the signal is received from the app the PCB Board has internal relays that act as control relays that send out voltage out of the PCB into main contactors when the contactor is actuated it sends voltage to the predetermine door or drawer of preference. There is a predetermined amount of time that is written within the System's App wherein the voltage will remove from the control relay, thus removing power from the voltage thus the latches will go into the lock up position when electrical power is removed because of a spring.

Another embodiment of how the linear electromagnetic actuator are utilized in the unlock position is they are powered unlocked when electrical power is removed a spring/magnet will return them to the lock position. The PCB can be mounted inside a plastic, metal or hybrid enclosure (combined metal and plastic) the enclosure consists of PCB, wiring, BUS bars, main contactors.

The PCB has inputs for RFID readers on it that can unlock or provide power to the control relay which will provide power to the contactor. The PCB utilizes an RFID port for wireless transmitter transmitting megahertz (MHz) from wireless remote control that will give the signal via the DOD I input on the PCB for the RFID.

When the wireless remote is pressed, the control relays will be energized for a predetermined amount of time that is programmable. The PCB has an input on it to connect a wired switch or “push button” one can use to unlock doors drawers for predetermined amount of time when electrical power will be removed.

The PCB has an input for an alarm, such that when the system is activated and the magnetic switch is utilized for the alarm if it doesn't sense the trigger that the door or drawer is closed, it will send a signal to a horn built into the PCB.

The PCB has a flashing light that serves as indicator light to indicate if it is connected to WiFi (802.11 or other applicable standards).

The PCB has the option of Ethernet LAN connection integrated in that the user can plug to the device to use the their internet instead of WiFi to connect to the App this could potentially be the case when a home is going under renovation or being built.

The number of contacts on PCB will depend on application: in baby proofing in a kitchen it may utilize a PCB with 8-10 control relays where a bathroom lower vanity may use only 1 control relay it all depends on the size.

The control relay provides power to contactor which can provide power to predetermine number of doors, drawers, cabinets, etc.

The electronic controller has a jack style connector for the voltage the voltage we use is low voltage DC.

This PCB has ability to use wireless remote control m addition to using the App. The PCB will also have a USB port to aid in configuration.

The enclosure has a power plug/adaptor female side and we just plug in the power to the adaptor. Depending on the application we may choose to utilize an internal power source.

As another embodiment of the installation, the System uses connectors that push and twist or push and lock with bus wires with positive and negative wires this wires are connected via heat shrink or tie wrap to ease installation and they are color-coded to ease installation. The System runs the wires down the length of the cabinet and the wire will be secured to the back behind the cabinet in some instances depending on access in some instances it will be secured under the counter which will be the preferred method for ease of installation they will be attached to a fastener, Velcro and secured with a screw when allowable.

Regarding the Linear Electromagnetic Actuator, electromagnets will be connected to the BUS wire with a T tap type of wire splice—an instant splice that will not require cutting wires.

In this regard, the linear electromagnetic actuator and the latch will be screwed to the cabinet or gate.

### Specifications Generally

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, Band C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least I” means I or more than 1. The term “at most” followed by a number (which may be a range having I or O as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” or “step” clause as specified in 35. U.S.C. § 112, i 6. Specifically, the use of “step of in the claims herein is not intended to invoke the provisions of U.S.C. § 112 P. 6.

1. A smart “baby gate” system for selectively locking and unlocking a gate, the system comprising: a CPU controller; at least one linear electromagnetic actuator locking device communicatively coupled to a controller wherein the controller is configured to facilitate locking and unlocking of at least one said electromagnetic device individually or in combination with at least one another electromagnetic locking device; and a remote control unit communicatively coupled to the controller for allowing a user to instruct the controller to trigger the locking and unlocking of said electromagnetic locking device, and a smart phone running a mobile application connected to WiFi chip on said controller which sends RF signal to the gate actuator (lock) to lock/unlock the gate (said controller being, in this embodiment, single relay); and an RF remote unit which sends a signal to the RF chip in controller, a power adapter converter/power supply power cord RF chip card input/wired in to PCB Board; sends signal to relay to unlock gate, LED indicator of gate status (open/closed), pairing button (wifi controller), wiring to unlock gate, controller power, inter alia Wegan protocol [typically RFID reader communicates with PCB to unlock gate] WiFi Chip, Alarm module, LED Light indicator (when RF signal is sent), RFID Chip (only one relay optimally needed), power source optionally battery pack of current life up to 10 hours or more, Micro SD Memory, USB Port, WiFi Card, Speaker, a microphone, Motion Sensor(s), a Flush mounted video camera, RF Remote unit, Fingerprint biometric reader, NC/CNC Access Code and processing Unit, optional RF remote with optional Wearable Bracelet, Remotely controlling Mobile App with Graphical User Interfaces with Menus and Settings and Options tailored to gate and user needs, optional Compact controller with Built-in RFID controller [alternate embodiment], optional window in gate for Antenna to prevent interference.

2. The system according to claim 1, wherein the plurality of electromagnet locking devices is communicatively connected to the controller using wires.

3. The system according to claim 1, wherein the plurality of electromagnet locking devices is communicatively connected to the controller using wires, and wherein the wires are connected to the controller using snap fit quick-release [optional screw-style] connectors.

4. The system according to claim 1, wherein the remote control unit wirelessly coupled to the controller.

5. The system according to claim 1, wherein the remote control unit is a smart touchscreen device, wherein the mobile Application is pre-installed in said smart device for allowing user to interact with the controller.

6. The system according to claim 1, wherein the plurality of electromagnetic locking devices comprises linear and angled solenoid locks, as well as magnetic latch locks.

7. The system according to claim 1, wherein the plurality of electromagnetic locking devices comprises linear and angled solenoid locks, as well as magnetic latch locks, and wherein the plurality of electromagnetic locking devices includes an indication light configured to indicate locked/unlocked state of the electromagnetic locking device.

8. The system according to claim 1, wherein the plurality of electromagnetic locking devices is wirelessly coupled to the controller.

9. The system according to claim 1, wherein the plurality of electromagnetic locking devices are battery-operated.

10. A system for selectively locking and unlocking a plurality of storage units, the system comprising:
a controller, wherein the controller comprises an optionally WiFi-controlled Printed Circuit Board (PCB), an optional wireless Wiegand system controller; and
a plurality of electromagnetic locking devices communicatively coupled to the controller, wherein the controller is configured to facilitate locking and unlocking of at least one electromagnetic device individually or in combination with at least one another electromagnetic locking device; and
a smart device communicatively coupled to the controller via a user's choice of Ethernet, LAN, WiFi and/or Bluetooth, for allowing said user to instruct the controller using an application pre-installed in said touchscreen smart device for allowing user to trigger the locking and unlocking of the at least one electromagnetic locking device, and wherein the touchscreen smart device is the user's choice of a smartphone, a tablet, or a laptop.

11. The system according to claim 10, wherein the application is configured to facilitate simultaneous or selective locking and unlocking the electromagnetic locking devices for a pre-determined time period using a plurality of operational modes, wherein the pre-determined time period ranges from about the preset of the time delay can be from about 2 seconds to about 2 hours.

12. The system according to claim 10, wherein the application is configured to facilitate simultaneous or selective locking and unlocking the electromagnetic locking devices for a pre-determined time period using a plurality of operational modes, wherein the pre-determined time period ranges from about 2 seconds to about 2 hours, and wherein the wires are connected to the controller using snap fit quick-release [optional screw-style] connectors.

13. The system according to claim 10, wherein the plurality of electromagnetic locking devices comprises linear and angled solenoid locks, as well as magnetic latch locks.

14. The system according to claim 10, wherein the plurality of electromagnetic locking devices includes an indication light configured to indicate locked/unlocked state of the electromagnetic locking device.

15. The system according to claim 10, wherein the plurality of electromagnetic locking devices is wirelessly coupled to the controller and are battery-operated.

16. A system for selectively locking and unlocking a plurality of storage units, the system comprising:
a controller, wherein the controller is a remotely-controlled Printed Circuit Board (PCB), and wherein the controller includes an RFID reader and corresponding ports, and wherein said controller is operable via a wall outlet 120 V transformed to 5-12 DC voltage with an optional/backup battery pack;
said system further comprising
a plurality of battery operated electromagnetic locking devices wirelessly communicatively coupled to the controller, wherein the wireless coupling is facilitated by RFID tags, wherein the controller is configured to facilitate locking and unlocking of at least one electromagnetic device individually or in combination with at least one another electromagnetic locking device; and
a remote control unit communicatively coupled to the controller via a user's choice of RFID tags, Ethernet, LAN, WiFi and Bluetooth, for allowing the user to instruct the controller to trigger the locking and unlocking of the at least one electromagnetic locking device.

17. The system according to claim 16, wherein the plurality of electromagnetic locking devices includes linear solenoid locks, angled solenoid locks, and magnetic latch locks.

18. The system according to claim 16, wherein the plurality of electromagnetic locking devices includes an indication light configured to indicate locked/unlocked state of the electromagnetic locking device.

19. A system for selectively locking and unlocking a plurality of storage units, the system comprising:
a controller wherein said controller is operable via a battery pack or a wall outlet 120 V transformed to 5-12 DC voltage; and
a plurality of electromagnetic locking devices communicatively coupled to the controller via wires, wherein the controller is configured to facilitate powering and locking and unlocking of at least one electromagnetic device individually or in combination with at least one another electromagnetic locking device; and
a remote control unit communicatively coupled to the controller for allowing a user to instruct the controller to trigger the locking and unlocking of the at least one electromagnetic locking device.

20. The system according to claim 10, wherein the wires are connected to the controller using screw connectors and snap fastening means, and wherein a portion of the wires are bonded via soldering to adjust to a user's custom needs
